(19) United States
(12) Patent Application Publication
(10) Pub. No.: US 2022/0063628 A1
(43) Pub. Date: Mar. 3, 2022

(54) METHOD FOR TRACTION-RELATED SPEED CONTROL OF A WORKING MACHINE

(71) Applicant: ZF Friedrichshafen AG, Friedrichshafen (DE)

(72) Inventors: Gerhard BAILLY, Friedrichshafen (DE); Wolfgang STRAIF, Schärding (AT); Florian ELSNER, Fellbach (DE)

(21) Appl. No.: 17/459,077

(22) Filed: Aug. 27, 2021

(30) Foreign Application Priority Data
Sep. 2, 2020 (DE) 10 2020 211 077.8

(51) Int. Cl. B60W 30/18

(52) U.S. Cl. CPC B60W 30/18172; B60W 2520/10; B60W 2520/12; B60W 2300/152; B60W 2520/28; B60W 2720/28; B60W 2720/26; B60W 2520/26

(57) ABSTRACT

A method (A) for the traction-related control of a drive-train of a working machine (1) having a drive unit (2), a transmission (3), a control unit (10) and first and second vehicle axles (7, 9) each supporting wheels (6, 8). At least one of the vehicle axles (7, 9) being driven, and following the entry of a drive requirement relating to a driving speed, wheel slip is iteratively reduced by adapting a rotational speed of the wheels (6, 8) of the driven vehicle axle (7, 9).

The present invention relates to a method for the traction-related speed control of a working machine or its drive-train. In addition a working machine is included, which can be operated by the method according to the invention.

From the prior art methods for slip regulation are known. Such methods are described, for example, in WO 2009/141181 A1, DE 102 19 270 C1 and US 2016/0039480 A1. The methods known from the prior art are based on the specification of a constant upper limit for the slip during driving. The slip at the driven wheels is regulated in such manner that a specified limit value is not exceeded. The traction efficiency depends on the drive force applied at each wheel and the drive slip. If the traction conditions are good, then the maximum traction efficiency occurs with very little drive slip. However, if the traction conditions deteriorate, for example due to driving over a loose surface or the occurrence of an external load, the relationship between the traction efficiency and the drive slip changes. The maximum traction efficiency is then displaced in the direction toward higher slip values. If a constant upper limit is specified for the permissible drive slip, the vehicle cannot bring to bear its full drive torque under all ground conditions.

The purpose of the present invention is to improve known methods for the traction-related control of a drive-train of a working machine, and in particular to provide a simplified method and thereby enable universal application with various vehicles.

That objective is achieved by the method according to the invention. In this case, the working machine comprises a drive unit, a transmission and a control unit. The drive unit is for example in the form of an internal combustion engine or an electric machine that can be operated as a motor or as a motor and generator. The drive unit can also be a hybrid arrangement and correspondingly the drive-train will comprise, besides an internal combustion engine, also an electric machine that can be operated purely as a motor or as a motor and generator. In addition the working machine has at least a first and a second vehicle axle with wheels, wherein at least one vehicle axle is driven, i.e. functionally connected to the drive-train consisting of the drive unit and the transmission. In other embodiments the working machine can have more than two vehicle axles and more than one vehicle axle can be driven.

Working machines are mainly building machines or agricultural or forestry vehicles. In particular, agricultural or forestry vehicles are tractors or farming tractors. As a rule, therefore, working machines have permanently built-on equipment or attachments that can be coupled to perform various types of work. It is also possible to choose between various different attachments or to operate with or without an attachment. In this context, attachments can be propelled only in front of or behind the working machine (for example a plow), or for active operation they can themselves comprise a drive unit, a working hydraulic system or some other actuating device. In such cases the power required is usually delivered by the working machine by way of a suitable interface. For various reasons, operating conditions of the working machine should be sought which ensure the least possible slip while at the same time maintaining a pre-set speed.

The transmission can be in the form of an automated transmission, a powershift transmission, a dual-clutch transmission or a hydrostatic or hydrostatic/mechanical power-branched transmission. Furthermore, both the drive unit and the transmission can comprise a separate computation unit through which access to the controls of the drive unit and/or the transmission takes place. In particular, an adaptation of the rotational speed and torque of the drive unit or an adaptation of a gear ratio of the transmission can thereby be achieved. Alternatively, the computation units can also be combined in a vehicle control computer or in the control unit.

The entry of a drive requirement relating to a driving speed of the working machine goes together with a reduction of wheel slip by adapting a rotational speed of the wheels on the driven vehicle axle. Such a drive requirement can be specified by an operator of the working machine, or entered via an external interface, for example for remote maintenance or diagnosis, or via an automated or autonomous control system of the working machine. In particular this same input of the drive requirement is the entry of a target driving speed of the working machine.

In a further development of the invention, a driving speed or a change of the driving speed is monitored. In this it is checked whether an adaptation of the rotational speed of the wheels has resulted in an expected change of the driving speed of the working machine. In particular, an increase of the driving speed is expected. If the above-described reaction (a change of the driving speed) does not occur, the adaptation of the rotational speed of the wheels is reversed. Causes for the non-occurrence of the reaction can for example be a poor condition of the roadway or a changed traction requirement by an attachment of the working machine. If the rotational speed adaptation in such a case were not to be reversed, then the increased wheel rotational speed would only give rise to greater power loss at the driven wheels, with damage to the ground as a result. This is avoided by reversing the rotational speed adaptation.

Starting from the entry of the drive requirement, the working machine will start off with a defined wheel slip at a first driving speed. This is understood to mean that by the control unit, a rotational speed of the drive unit and a gear ratio of the transmission are set in such manner that with a given wheel diameter of the vehicle a driving speed close to the target driving speed can be expected. It is true that by way of the set rotational speed of the drive unit, the set gear ratio of the transmission and taking into account a fixed gear ratio of the vehicle's axles in combination with a known wheel diameter, the target speed can theoretically be set exactly, but a driving movement of the working machine is only possible in combination with slip at the wheels. For that reason the driving speed over the ground differs from the theoretically set driving speed. Correspondingly, a slip compensation can be set as a specification for a defined wheel slip, for example in that a theoretical driving speed is set which is higher than the target driving speed by a defined value. For example that value can be 5%, but other values too are possible, depending on the design of the working machine, its mode of operation and/or the ground conditions of the roadway.

By means of a suitable measuring device the (actual) driving speed of the working machine over the ground is determined. The measuring device can for example comprise a radar, Lidar, GPS, or an optical sensor for image evaluation. From a comparison between the theoretical driving speed or driving specification and the actual driving speed, the current wheel slip at the driven wheels can be determined.

The measured (actual) driving speed is then compared with the driving specification, i.e. the target driving speed. If the actual driving speed is higher than the driving specification, the drive output rotational speed of the transmission is reduced either by an intervention at the control system of the drive unit (reducing the rotational speed of the drive unit), and/or by adapting the gear ratio of the transmission. This reduction also takes place when the actual driving speed is identical to the driving specification. The reduction of the drive output rotational speed of the transmission also results in a reduction of the wheel slip at the driven wheels.

Thereafter, the measurement of the actual driving speed, the calculation of the wheel slip and the comparison between the actual driving speed and the driving specification are repeated. This loop of following the process is repeated until the actual driving speed is lower than the driving specification. Instead of reducing the drive output rotational speed of the transmission, in contrast the drive output rotational speed of the transmission and hence also the wheel slip at the wheels are now increased.

After the above the actual driving speed is checked or monitored. This means that a check is carried out to see whether increasing the drive output rotational speed of the transmission has also resulted in a change, in particular an increase of the actual driving speed. If that is so, the previous increase of the drive output rotational speed of the transmission is maintained. Otherwise, the increase of the drive output rotational speed of the transmission is reversed. In both case the measurement of the actual driving speed, the calculation of the wheel slip, the comparison between the actual driving speed and the driving specification and the increase or reduction of the drive output rotational speed of the transmission, are repeated until the above-described conditions are fulfilled.

The sequence of steps of the method serves the purpose of fulfilling the drive requirement with the least possible slip at the driven wheels. It is continually checked whether the drive requirement can be fulfilled or achieved with (still) less wheel slip. This makes for the best possible care of the ground and minimizes the power loss between the wheels and the roadway. At the same time, the continual checking makes it possible to react to changing influential factors, for example a change of the roadway. This means in particular that during working operation the working machine is typically equipped with an attachment which, due to the condition of the roadway (ground) or a change of the operating conditions of the attachment, causes the traction force requirement to vary. This too can be coped with thanks to the method according to the invention. In the ideal case, a compensation takes place. Furthermore the condition of the roadway in the contact area with the wheels can vary, for example due to weathering influences (wetness, mud, ice, snow), or the composition of the roadway can change (moving from a compacted roadway to a loose one, or from a sandy roadway to one containing loam, etc.). Both these can result in variations of the slip between the wheels and the roadway, or variations of the traction.

According to another aspect of the present invention, a working machine with a drive unit, a transmission and a control unit is also included. By way of a driveshaft, drive input shaft power is passed into the transmission and by way of a drive output shaft the resulting drive output power is transmitted to the wheels of a first and/or second vehicle axle. The control unit of the working machine is designed to carry out the method according to the invention.

The invention will be explained in greater detail with reference to the attached figures, which show:

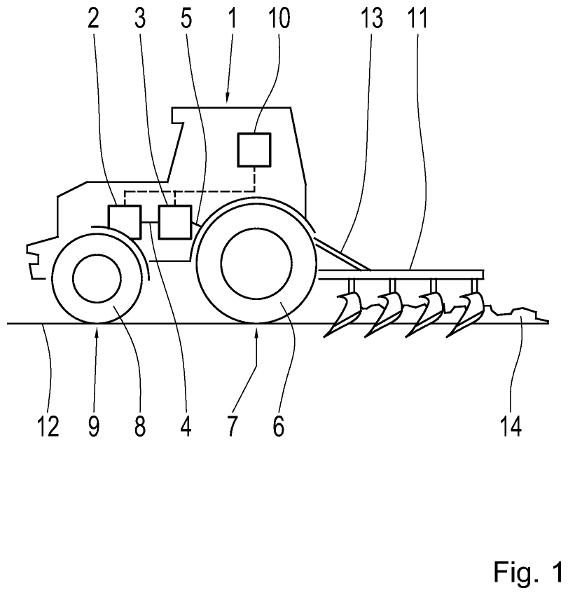

FIG. 1: A schematic representation of a working machine with an attachment;

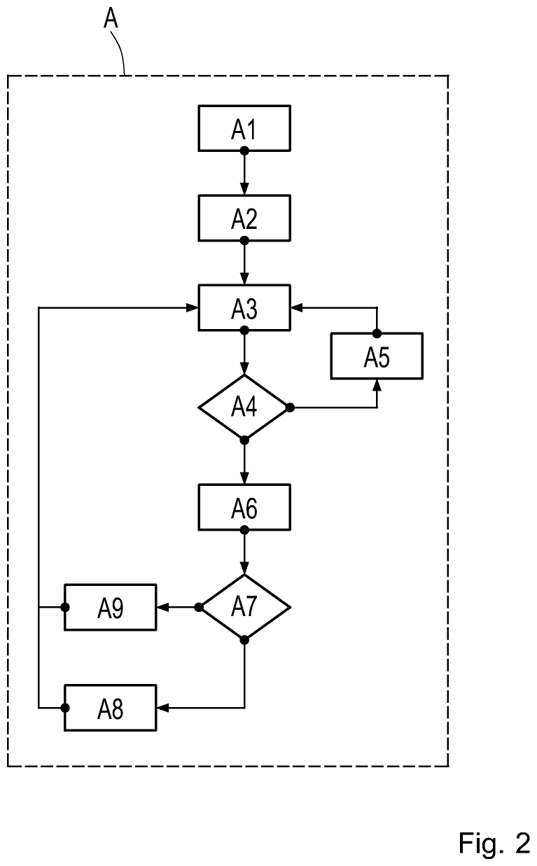

FIG. 2: A schematic representation of a flow chart of the method for traction-related speed control of a working machine.

In a greatly simplified schematic representation, FIG. 1 shows a working machine 1 with an attachment 11. In the present case, the working machine 1 is in the form of a tractor or farming tractor, and comprises a drive unit 2, a transmission 3 and a control unit 10. The drive unit is connected by way of a drive input shaft 4 to an input of the transmission 3, whereas an output of the transmission 3 is connected by way of a drive output shaft 5 to a first vehicle axle 7 and the wheels 6 fitted thereto. The drive unit 2 delivers a drive input power, which by way of the driveshaft 4 is passed into the transmission 3 and, in accordance with the set gear ratio, is transmitted by the drive output shaft 5 to the first vehicle axle 7. In this case the working machine 1 has a second vehicle axle 9 to which wheels 8 are fitted. The second vehicle axle 9 can also be connected to the drive output shaft 5 or to the first vehicle axle 7, and in that case all the wheels 6, 8 of the working machine 1 will be driven wheels.

The control unit 10 is connected for signal exchange with the transmission 3 and/or the drive unit 2, as illustrated by the broken lines. Moreover, the control unit 10 comprises a sensor or measuring device (not shown) for detecting the driving speed of the working machine 1. Instead of being integrated in the control unit 10, the sensor can also be a separate component with a signal-transmitting connection.

The attachment 11 is in the present case in the form of a plow. In alternative embodiments it can also be any other agricultural attachment for working the soil or for crop harvesting. In the simplest version it can also be a trailer. By means of a lifting device 13 the height of the attachment 11 can be adjusted, in particular that of the plow. Depending on the lifting height of the attachment 11 set, a sinking depth into the ground 12 changes. In particular, the ground 12 is the surface of an agriculturally useful area. In alternative embodiments, however, the ground 12 can be a pathway or a street, and in such cases attachments 11 different from the plow in the present case are attached to the working machine 1. By virtue of the contact of the attachment 11 with the ground 12, the latter is broken or dug up, as indicated by a raised area 14 in the figure.

FIG. 2 shows a schematic representation of a flow chart of the method for the traction-related speed control of the working machine 1. When a drive requirement relating to a driving speed is entered, the wheel slip is reduced iteratively by adapting a rotational speed of the wheels 6, 8 of the driven vehicle axles 7, 9.

For this, in a first process step A1 the drive requirement is entered. In a second process step A2 the working machine 1 drives off at a first driving speed with a defined wheel slip. In a third process step A3, an actual driving speed of the working machine 1 is measured and a current wheel slip corresponding to it is calculated. In a fourth process step A4, the actual driving speed is compared with the target driving speed. In a fifth process step A5 the rotational speed of the wheels 6, 8 is reduced and a return to the third process step A3 is initiated if the actual driving speed is higher than or equal to the target driving speed. On the other hand, in a sixth process step A6 the rotational speed of the wheels 6, 8 is increased if, when compared in the fourth process step A4, the actual driving speed is found to be lower than the target driving speed.

The sixth process step A6 is followed by a seventh process step A7 in which the actual driving speed is monitored. During this it is checked whether the actual driving speed has increased in reaction to the increase of the rotational speed of the wheels 6, 8 in the sixth process step A6. If not, in an eighth process step A8 the increase of the rotational speed of the wheels 6, 8 is reversed and the process reverts to the second process step A2. Otherwise, in a ninth process step A9 the increase of the rotational speed of the wheels 6, 8 is maintained if it has been found in the seventh process step A7 that the actual driving speed has increased in reaction to the increase of the rotational speed of the wheels 6, 8 in the sixth process step A6. The ninth process step A9 is likewise followed by a return to the second process step A2.

### INDEXES

1 Working machine
2 Drive unit
3 Transmission
4 Drive input shaft
5 Drive output shaft
6 Wheel
7 First vehicle axle
8 Wheel
9 Second vehicle axle
10 Control unit
11 Attachment
12 Roadway
13 Lifting device
14 Raised area
A Method
A1-A8 Process steps

1-7. (canceled)

8. A method (A) for traction-related control of a drive-train of a working machine (1) having a drive unit (2), a transmission (3), a control unit (10) and first and second vehicle axles (7, 9) with wheels (6, 8), the method comprising:
driving at least one of the vehicle axles (7, 9),
entering a drive requirement relating to a driving speed, and
iteratively reducing a wheel slip by adapting a rotational speed of the wheels (6, 8) of the driven vehicle axle (7, 9).

9. The method (A) according to claim 8, further comprising reducing or increasing the rotational speed of the wheels (6, 8) depending on a difference between an actual driving speed and a target driving speed.

10. The method (A) according to claim 8, further comprising monitoring a change of the driving speed, in reaction to an adaptation of the rotational speed of the wheels (6, 8), and, if an expected change of the actual driving speed has not occurred, reversing the adaptation of the rotational speed of the wheels (6, 8).

11. The method (A) according to claim 8, further comprising
in a first process step (A1), entering the drive requirement;
in a second process step (A2), starting the working machine (1) off at a first driving speed and with a defined wheel slip;
in a third process step (A3), measuring an actual driving speed of the working machine (1) and calculating a corresponding actual wheel slip;
in a fourth process step (A4), comparing the actual driving speed with the target driving speed, and, if the actual driving speed is higher than or equal to the target driving speed, in a fifth process step (A5), reducing the rotational speed of the wheels (6, 8) and the method reverts to the third process step (A3), and, in a sixth process step (A6), increasing the rotational speed of the wheels (6, 8) if during the comparison during the fourth process step (A4) the actual driving speed is found to be lower than the target driving speed.

12. The method (A) according to claim 11, further comprising, in a seventh process step (A7), monitoring the actual driving speed, checking whether the actual driving speed has increased in reaction to the increase of the rotational speed of the rotational speed of the wheels (6, 8) in the sixth process step (A6), and then maintaining the increase of the rotational speed in accordance with a ninth process step (A9) and returning to the second process step (A2), whereas otherwise the increase of the rotational speed of the wheels (6, 8) is reversed in an eighth process step (A8) and a return to the second process step (A2) then occurs.

13. The method (A) according to claim 8, further comprising also entering a specification for the wheel slip besides a drive requirement.

14. A working machine (1) with a drive unit (2), a transmission (3) and a control unit (10), wherein drive power is passed to the transmission (3), by way of a drive input shaft (4), and resulting drive power is transmitted, by way of a drive output shaft (5), to wheels (6, 8) of at least one of a first and a second vehicle axle (7, 9), and the control unit (10) is suitable for and designed to carry out the method (A) of the invention according to claim 8.
